(19) United States
(12) Patent Application Publication
(10) Pub. No.: US 2025/0249427 A1
(43) Pub. Date: Aug. 7, 2025

(54) PREPARATION METHOD OF GRAPHENE-BASED COMPOSITE AEROGEL MATERIAL FOR ADSORBING HEAVY METAL IONS

(71) Applicant: Kunming University of Science and Technology, Kunming (CN)

(72) Inventors: Jinming Cai, Kunming (CN); Xiaoming Cai, Kunming (CN); Quan Gou, Kunming (CN); Zhiwu Zhang, Kunming (CN); Jiafei Jin, Kunming (CN); Ziming Zhao, Kunming (CN)

(21) Appl. No.: 19/032,471

(22) Filed: Jan. 21, 2025

(30) Foreign Application Priority Data
Feb. 1, 2024 (CN) 2024101460256

(51) Int. Cl. B01J 20/20; B01J 20/24; B01J 20/28; B01J 20/30; C02F 1/28; C02F 101/20

(52) U.S. Cl. CPC B01J 20/205; B01J 20/24; B01J 20/28026; B01J 20/28047; B01J 20/3042; B01J 20/3071; B01J 20/3085; C02F 1/288; C02F 1/283; C02F 1/285; C02F 1/286; C02F 2101/20

(57) ABSTRACT

A preparation method of a graphene-based composite aerogel material for adsorbing heavy metal ions especially for a chelating agent/polymer/graphene composite aerogel material, includes: (1) preparing a chelating agent active solution; (2) preparing a GO/polymer mixed solution; (3) mixing the GO/polymer mixed solution with the chelating agent active solution to obtain the graphene-based composite aerogel material through a hydrothermal reaction. The polymer is used to enhance the mechanical strength of the aerogel and the chelating agent is used to improve the adsorption performance of the aerogel. The hydrothermal reaction is utilized to reduce graphene oxide to partially reduced graphene oxide, thereby forming a graphene-based aerogel. The composite aerogel has a high specific surface area and good mechanical strength. Moreover, active sites provided by the chelating agent and graphene further enhance the adsorption performance of the composite aerogel for metal ions.

### CROSS-REFERENCE TO RELATED APPLICATION

This application claims priority to Chinese Patent Application No. 202410146025.6, filed on Feb. 1, 2024, which is herein incorporated by reference in its entirety.

### TECHNICAL FIELD

The disclosure relates to the field of materials for adsorbing metal ions, and more particularly to a preparation method of a graphene-based composite aerogel material for adsorbing heavy metal ions.

### BACKGROUND

Heavy metal pollution, due to its toxicity and non-biodegradability in the human body, has been recognized as a serious global environmental problem. Therefore, depth treatment of heavy metals in water is an urgent requirement.

Currently, the treatment of heavy metals in wastewater mainly relies on physical and chemical methods, including the chemical precipitation method, extraction method, electrochemical method, biological removal method, and catalytic reduction method. However, these methods have drawbacks such as low purification efficiency, easy saturation, difficulty in regeneration, and high costs. The adsorption method offers advantages such as simple operation, long-term stability, low cost, and no secondary pollution. Many adsorbents are developed, such as activated carbon, resins, metal-organic frameworks (MOF), and metal oxides. However, the traditional adsorbents have poor adsorption capacity for pollutants and low adsorption ability for chemical substances, which limits their practical application in industry.

Graphene, due to its excellent physical and chemical properties, is developed and utilized in various fields. As a derivative of the graphene, graphene oxide (GO) exhibits excellent physical and chemical adsorption capabilities due to the presence of a large number of hydroxyl, epoxy, carboxyl, and oxygen-containing polar groups on both sides and edges of its plane. The GO, due to its large specific surface area, is widely applied in the adsorption of organic pollutants and the heavy metals in wastewater in recent years, attracting worldwide attention. Studies show that the GO has strong adsorption capacity for heavy metals such as cadmium (Cd)(II), chromium (Cr)(VI), uranium (U)(VI), and lead (Pb)(II) in water, and other organic pollutants. Despite the outstanding adsorption performance of GO, the GO is difficult to separate from water after adsorption due to its hydrophilic nature, and surface-modified GO adsorbents can affect the adsorption performance of the heavy metal ions.

Therefore, it is particularly important to develop an adsorbent that is easy to separate from water and has high adsorption performance.

### SUMMARY

A purpose of the disclosure is to solve problems of low utilization rate, small adsorption capacity, easy loss with water flow, and difficulty in recycling and reuse of existing powdered adsorbents. The disclosure provides a graphene-based composite aerogel material with good adsorption performance, stability, and reusability. The graphene-based composite aerogel material provided by the disclosure is a functionalized graphene-based composite aerogel that exhibits excellent heavy metal adsorption effects with good stability, and is reusable.

The purpose of the disclosure is achieved by the following technical solutions: a preparation method of the graphene-based composite aerogel material for adsorbing heavy metal ions includes the following steps:
(1) dissolving a chelating agent into an ammonia aqueous solution, followed by sequentially adding 1-(3-dimethylaminopropyl)-3-ethylcarbodiimide (EDC) and N-hydroxy succinimide (NHS) as activators and then stirring uniformly to obtain a chelating agent active solution;
(2) mixing a dispersion of GO with a solution of a polymer, followed by ultrasonicating and then stirring to obtain a GO/polymer mixed solution;
(3) mixing the GO/polymer mixed solution with the chelating agent active solution to obtained a mixture solution, adding diethylenetriamine as a crosslinking agent to the mixture solution, followed by stirring, and then adding glucose as a reducing agent to thereby obtain a composite graphene suspension; and
(4) performing a hydrothermal reaction on the composite graphene suspension, followed by rinsing and freeze-drying operations to thereby obtain the graphene-based composite aerogel material.

In an embodiment, the chelating agent in the step (1) is one or more selected from the group consisting of diethylenetriaminepentaacetic acid (DTPA), ethylenediaminetetraacetic acid (EDTA), N-(2-hydroxyethyl) ethylenediamine-N,N′,N′-triacetic acid (HEDTA), glycol-bis-(2-aminoethylether)-N,N,N′,N′-tetraacetic acid (EGTA), ethylenediamine diacetate acid (EDDHA), (1,2-cyclohexylenedinitrilo)-tetraacetic acid (CDTA), S,S-ethylenediaminedisuccinic acid (S,S-EDDS), nitrilotriacetic acid (NTA), citric acid, and N,N-dihydroxyethylglycine (DEG). A concentration of the chelating agent is in a range of 1 milligram per milliliter (mg/mL) to 8 mg/mL.

In an embodiment, in the step (1), a concentration of the ammonia aqueous solution is in a range of 0.5-1 mole per liter (mol/L), and a concentration of each of the EDC and the NHS is in a range of 0.01 mol/L to 0.03 mol/L.

In an embodiment, in the step (1), the stirring after adding the EDC and the NHS lasts for 0.5 h to 4 h.

In an embodiment, in the step (2), a concentration of the dispersion of GO is in a range of 0.2 mg/mL to 0.8 mg/mL.

In an embodiment, in the step (2), the polymer is one or more selected from the group consisting of carboxymethyl cellulose (CMC), chitosan, polyvinyl alcohol, and polyethylene glycol. A weight ratio of the polymer to the GO is 0.125-2:1. In a specific embodiment, the polymer is the CMC, and a weight ratio of the CMC to the GO is 0.125-2:1.

In an embodiment, in the step (2), the ultrasonicating is under a power in a range of 100 watts (W) to 300 W for 0.5 hours (h) to 2 h, and the stirring specifically lasts for 0.5 h to 2 h.

In an embodiment, in the step (3), the crosslinking agent is the diethylenetriamine, and a weight concentration of the diethylenetriamine is in a range of 3% to 10%.

In an embodiment, in the step (3), time for the stirring is in a range of 4 h to 12 h.

In an embodiment, a weight of the glucose is 2 to 6 times a weight of GO.

In an embodiment, in the step (4), a temperature for the hydrothermal reaction is in a range of 60° C. to 100° C., and time for the hydrothermal reaction is in a range of 2 h to 8 h.

In an embodiment, in the step (4), the rinsing operation includes: rinsing by deionized water and dialyzing for 2 to 7 days until potential of hydrogen (pH) is in a range of 5 to 9, the freeze-drying operation includes pre-freezing and then freeze-drying, a temperature for the pre-freezing is in a range of −5° C. to 196° C., time for the pre-freezing is in a range of 24 h to 72 h, a pressure for the freeze-drying is 2 pascals (Pa) to 50 Pa, a temperature for the freeze-drying is in a range of −5° C. to 196° C., and time for the freeze-drying is in a range of 24 h to 72 h.

Compared to the related art, the disclosure has the following beneficial effects.

(1) In the disclosure, the adsorption capacity of the GO is enhanced through DTPA modification, the structural stability of the composite aerogel in liquids is improved by compounding with CMC, and a ternary composite graphene-based aerogel which is green and environmentally friendly is thereby obtained. The graphene-based composite aerogel material has a structure rich in carboxyl, hydroxyl and amino groups, and has a strong adsorption capacity for the heavy metal ions.

(2) The graphene-based composite aerogel material as an adsorbent has a lightweight, porous, and controllably shaped bulk structure. The bulk graphene aerogel features a porous structure with a specific surface area of over 100 square meters per gram (m²/g). The interconnected internal pores effectively reduce water flow resistance and enhance the mass transfer efficiency of the heavy metal ions. The pseudo-second-order kinetic model predicts a maximum adsorption capacity of 521.92 milligrams per gram (mg/g) of the graphene-based composite aerogel material for lead ions (Pb²⁺).

(3) The composite GO aerogel prepared by the disclosure for adsorbing the heavy metals in solutions is simple to operate and has a short adsorption cycle. In practical applications, the bulk composite GO aerogel is filled into a cylindrical container. The heavy metal-containing solution flows in from a side and out from another side, completing the adsorption process. For a Pb²⁺ solution with a concentration of 100 milligrams per liter (mg/L) and a volume of 100 milliliters (mL), approximately 95% of Pb²⁺ can be adsorbed by the graphene-based composite aerogel material. Moreover, Pb²⁺ can be easily desorbed through the graphene-based composite aerogel material in hydrogen chloride (HCl) solution, allowing for multiple regeneration and recycling uses of the graphene-based composite aerogel material.

(4) The preparation process is scientifically reasonable, the preparation method is simple, and the obtained aerogel is practical and effective.

### BRIEF DESCRIPTION OF DRAWINGS

In order to provide a clearer explanation of exemplary embodiments of the disclosure or the technical solutions in the related art, a brief introduction is given to the accompanying drawings required for the description of the exemplary embodiments or the related art. It is apparent that the accompanying drawings described below are some embodiments of the disclosure. For those skilled in the art, other drawings can be obtained based on these drawings without creative labor.

FIG. 1 illustrates scanning electron microscopy (SEM) and energy-dispersive spectroscopy (EDS) images of a graphene-based composite aerogel material for adsorbing heavy metal ions before adsorption of heavy metal ions (denoted by (a) and after adsorption of heavy metal ions (denoted by (b)).

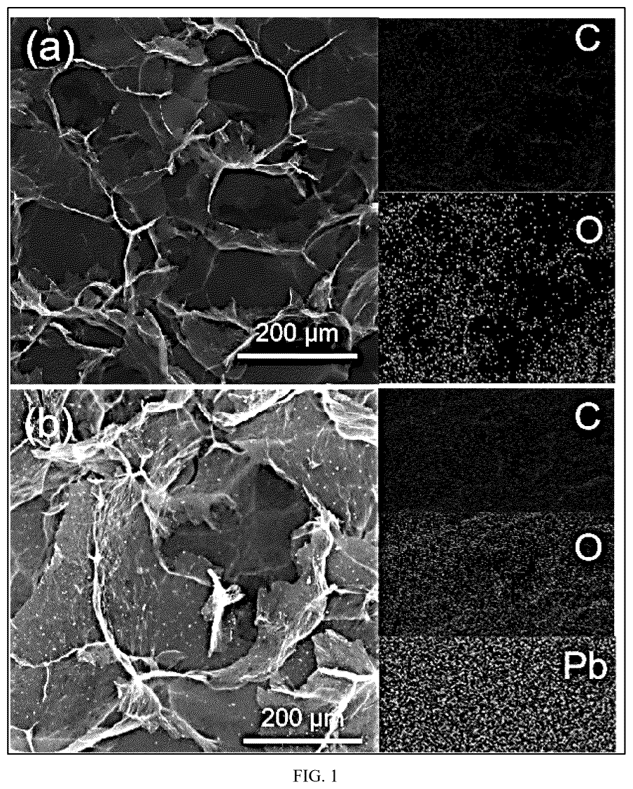

FIG. 2 illustrates photographs of the graphene-based composite aerogel material and its appearances before and after being subjected to heavy pressure.

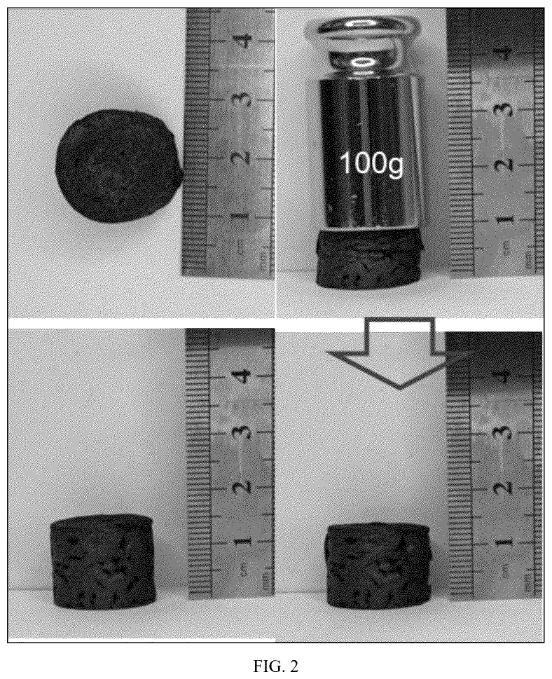

FIG. 3 illustrates an adsorption kinetics graph of the graphene-based composite aerogel material.

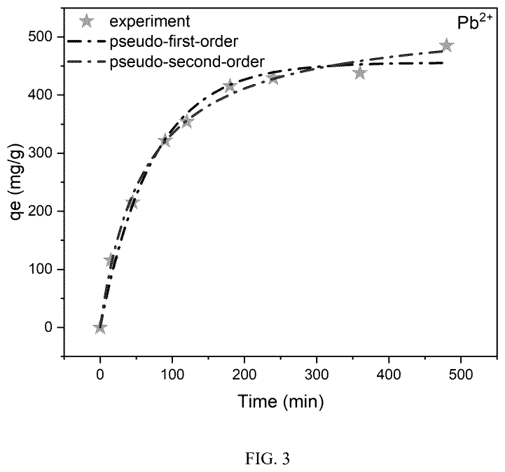

### DETAILED DESCRIPTION OF EMBODIMENTS

In order to make the technical means, creative features, and the effectiveness achieved by the disclosure more easily understood, the following embodiments, combined with the attached drawings, provide a specific explanation of a graphene-based composite aerogel material for adsorbing heavy metal ions as described in the disclosure.

### Embodiment 1

A preparation method of a CMC/DTPA/graphene-based aerogel material for adsorbing metal ions, includes the following steps.

Step 1, 0.4 grams (g) of DTPA is dissolved into 10 mL of ammonia aqueous solution, and then 35 mL of deionized water, 0.45 g of EDC and 0.3 g of NHS are added followed by stirring magnetically at room temperature for 2 h to obtain a DTPA active solution.

Step 2, 0.4 g of GO powder is dissolved into 40 mL of deionized water followed by ultrasonicating for 0.5 h and then stirring for 0.5 h to obtain a dispersion of GO, and 0.1 g of CMC is dissolved into 10 mL of deionized water followed by ultrasonicating for 0.5 h and then stirring for 0.5 h to obtain a CMC solution.

Step 3, the dispersion of GO and the CMC solution are mixed and then ultrasonicated for 0.5 h and stirred for 0.5 h to obtain a GO/polymer mixed solution, the GO/polymer mixed solution is added to the DTPA active solution to obtain a mixture solution, and the mixture solution is added with 5 mL of diethylenetriamine followed by stirring for 6 h to obtain a stirred solution.

Step 4, the stirred solution is added with 1.6 g of glucose and then stirred for 0.5 h to obtain a CMC/DTPA/graphene mixed solution.

Step 5, the CMC/DTPA/graphene mixed solution is added to a 10 mL sample bottle and then is performed with a hydrothermal reaction at 70° C. for 4 h to obtain a CMC/DTPA/graphene hydrogel.

Step 6, the CMC/DTPA/graphene hydrogel is placed in deionized water for dialysis for 5 days until supernatant becomes neutral and then placed at −10° C. for pre-freezing for 48 h followed by vacuum freeze-drying at −45° C. for 72 h to obtain the CMC/DTPA/graphene-based aerogel material.

### Embodiment 2

A preparation method of a CMC/DTPA/graphene-based aerogel material for adsorbing metal ions, includes the following steps.

Step 1, 0.2 g of DTPA is dissolved into 10 mL of an ammonia aqueous solution, and then 35 mL of deionized water, 0.45 g of EDC and 0.3 g of NHS are added followed by stirring magnetically at room temperature for 2 h to obtain a DTPA active solution.

Step 2, 0.4 g of GO powder is dissolved into 40 mL of deionized water followed by ultrasonicating for 0.5 h and then stirring for 0.5 h to obtain a dispersion of GO, and 0.05 g of CMC is dissolved into 10 mL of deionized water followed by ultrasonicating for 0.5 h and then stirring for 0.5 h to obtain a CMC solution.

Step 3, the dispersion of GO and the CMC solution are mixed and then ultrasonicated for 0.5 h and stirred for 0.5 h to obtain a GO/polymer mixed solution, the GO/polymer mixed solution is added to the DTPA active solution to obtain a mixture solution, and the mixture solution is added with 5 mL of diethylenetriamine followed by stirring for 6 h to obtain a stirred solution.

Step 4, the stirred solution is added with 1.6 g of glucose and then stirred for 0.5 h to obtain a CMC/DTPA/graphene mixed solution.

Step 5, the CMC/DTPA/graphene mixed solution is added to a 10 mL sample bottle and then is performed with a hydrothermal reaction at 70° C. for 4 h to obtain a CMC/DTPA/graphene hydrogel.

Step 6, the CMC/DTPA/graphene hydrogel is placed in deionized water for dialysis for 5 days until supernatant becomes neutral and then placed at −10° C. for pre-freezing for 48 h followed by vacuum freeze-drying at −45° C. for 72 h to obtain the CMC/DTPA/graphene-based aerogel material.

### Embodiment 3

A preparation method of a CMC/DTPA/graphene-based aerogel material for adsorbing metal ions, includes the following steps.

Step 1, 0.4 g of DTPA is dissolved into 10 mL of an ammonia aqueous solution, and then 35 mL of deionized water, 0.45 g of EDC and 0.3 g of NHS are added followed by stirring magnetically at room temperature for 2 h to obtain a DTPA active solution.

Step 2, 0.3 g of GO powder is dissolved into 40 mL of deionized water followed by ultrasonicating for 0.5 h and then stirring for 0.5 h to obtain a dispersion of GO, and 0.1 g of CMC is dissolved into 10 mL of deionized water followed by ultrasonicating for 0.5 h and then stirring for 0.5 h to obtain a CMC solution.

Step 3, the dispersion of GO and the CMC solution are mixed and then ultrasonicated for 0.5 h and stirred for 0.5 h to obtain a GO/polymer mixed solution, the GO/polymer mixed solution is added to the DTPA active solution to obtain a mixture solution, and the mixture solution is added with 5 mL of diethylenetriamine followed by stirring for 6 h to obtain a stirred solution.

Step 4, the stirred solution is added with 1.6 g of glucose and then stirred for 0.5 h to obtain a CMC/DTPA/graphene mixed solution.

Step 5, the CMC/DTPA/graphene mixed solution is added to a 10 mL sample bottle and then is performed with a hydrothermal reaction at 60° C. for 4 h to obtain a CMC/DTPA/graphene hydrogel.

Step 6, the CMC/DTPA/graphene hydrogel is placed in deionized water for dialysis for 5 days until supernatant becomes neutral and then placed at −10° C. for pre-freezing for 48 h followed by vacuum freeze-drying at −45° C. for 72 h to obtain the CMC/DTPA/graphene-based aerogel material.

### Embodiment 4

A preparation method of a CMC/EDTA/graphene-based aerogel material for adsorbing metal ions, includes the following steps.

Step 1, 0.4 g of EDTA is dissolved into 10 mL of an ammonia aqueous solution, and then 35 mL of deionized water, 0.45 g of EDC and 0.3 g of NHS are added followed by stirring magnetically at room temperature for 2 h to obtain an EDTA active solution.

Step 2, 0.4 g of GO powder is dissolved into 40 mL of deionized water followed by ultrasonicating for 0.5 h and then stirring for 0.5 h to obtain a dispersion of GO, and 0.1 g of CMC is dissolved into 10 mL of deionized water followed by ultrasonicating for 0.5 h and then stirring for 0.5 h to obtain a CMC solution.

Step 3, the dispersion of GO and the CMC solution are mixed and then ultrasonicated for 0.5 h and stirred for 0.5 h to obtain a GO/polymer mixed solution, the GO/polymer mixed solution is added to the EDTA active solution to obtain a mixture solution, and the mixture solution is added with 5 mL of diethylenetriamine followed by stirring for 6 h to obtain a stirred solution.

Step 4, the stirred solution is added with 1.6 g of glucose and then stirred for 0.5 h to obtain a CMC/EDTA/graphene mixed solution.

Step 5, the CMC/EDTA/graphene mixed solution is added to a 10 mL sample bottle and then is performed with a hydrothermal reaction at 70° C. for 4 h to obtain a CMC/EDTA/graphene hydrogel.

Step 6, the CMC/EDTA/graphene hydrogel is placed in deionized water for dialysis for 5 days until supernatant becomes neutral and then placed at −10° C. for pre-freezing for 48 h followed by vacuum freeze-drying at −45° C. for 72 h to obtain the CMC/EDTA/graphene-based aerogel material.

### Embodiment 5

A preparation method of a polyvinyl alcohol/EDTA/graphene-based aerogel material for adsorbing metal ions, includes the following steps.

Step 1, 0.4 g of EDTA is dissolved into 10 mL of an ammonia aqueous solution, and then 35 mL of deionized water, 0.45 g of EDC and 0.3 g of NHS are added followed by stirring magnetically at room temperature for 2 h to obtain an EDTA active solution.

Step 2, 0.4 g of GO powder is dissolved into 40 mL of deionized water followed by ultrasonicating for 0.5 h and then stirring for 0.5 h to obtain a dispersion of GO, and 0.1 g of polyvinyl alcohol is dissolved into 10 mL of deionized water followed by ultrasonicating for 0.5 h and then stirring for 0.5 h to obtain a polyvinyl alcohol solution.

Step 3, the dispersion of GO and the polyvinyl alcohol solution are mixed and then ultrasonicated for 0.5 h and stirred for 0.5 h to obtain a GO/polymer mixed solution, the GO/polymer mixed solution is added to the EDTA active solution to obtain a mixture solution, and the mixture solution is added with 5 mL of diethylenetriamine followed by stirring for 6 h to obtain a stirred solution.

Step 4, the stirred solution is added with 1.6 g of glucose and then stirred for 0.5 h to obtain a polyvinyl alcohol/EDTA/graphene mixed solution.

Step 5, the polyvinyl alcohol/EDTA/graphene mixed solution is added to a 10 mL sample bottle and then is performed with a hydrothermal reaction at 70° C. for 4 h to obtain a polyvinyl alcohol/EDTA/graphene hydrogel.

Step 6, the polyvinyl alcohol/EDTA/graphene hydrogel is placed in deionized water for dialysis for 5 days until supernatant becomes neutral and then placed at −10° C. for pre-freezing for 48 h followed by vacuum freeze-drying at −45° C. for 72 h to obtain the polyvinyl alcohol/EDTA/graphene-based aerogel material.

The above embodiments are illustrated implementation schemes of the disclosure. In addition, the disclosure can also be implemented in other ways, and any apparent substitution is within the scope of protection of the disclosure without departing from the inventive concept.

What is claimed is:

1. A preparation method of a graphene-based composite aerogel material for adsorbing heavy metal ions, comprising the following steps:
(1) dissolving a chelating agent into an ammonia aqueous solution, followed by sequentially adding 1-(3-dimethylaminopropyl)-3-ethylcarbodiimide (EDC) and N-hydroxy succinimide (NHS) as activators and then stirring uniformly to obtain a chelating agent active solution;
(2) mixing a dispersion of graphene oxide (GO) with a solution of a polymer, followed by ultrasonicating, and then stirring to obtain a GO/polymer mixed solution;
(3) mixing the GO/polymer mixed solution with the chelating agent active solution to obtained a mixture solution, adding diethylenetriamine as a crosslinking agent to the mixture solution, followed by stirring, and then adding glucose as a reducing agent to thereby obtain a composite graphene suspension; and
(4) performing a hydrothermal reaction on the composite graphene suspension, followed by rinsing and freeze-drying operations to thereby obtain the graphene-based composite aerogel material.

2. The preparation method of the graphene-based composite aerogel material for adsorbing the heavy metal ions as claimed in claim 1, wherein the chelating agent in the step (1) is one or more selected from the group consisting of diethylenetriaminepentaacetic acid (DTPA), ethylenediaminetetraacetic acid (EDTA), N-(2-hydroxyethyl) ethylenediamine-N,N′,N′-triacetic acid (HEDTA), glycol-bis-(2-aminoethylether)-N,N,N′,N′-tetraacetic acid (EGTA), ethylenediamine diacetate acid (EDDHA), (1,2-cyclohexylenedinitrilo)-tetraacetic acid (CDTA), S,S-ethylenediaminedisuccinic acid (S,S-EDDS), nitrilotriacetic acid (NTA), citric acid, and N,N-dihydroxyethylglycine (DEG), and a concentration of the chelating agent is in a range of 1 milligram per milliliter (mg/mL) to 8 mg/mL.

3. The preparation method of the graphene-based composite aerogel material for adsorbing the heavy metal ions as claimed in claim 1, wherein in the step (1), a concentration of the ammonia aqueous solution is in a range of 0.5 moles per liter (mol/L) to 1 mol/L, and a concentration of each of the EDC and the NHS is in a range of 0.01 mol/L to 0.03 mol/L.

4. The preparation method of the graphene-based composite aerogel material for adsorbing the heavy metal ions as claimed in claim 1, wherein in the step (2), a concentration of the dispersion of GO is in a range of 0.2 mg/mL to 0.8 mg/mL.

5. The preparation method of the graphene-based composite aerogel material for adsorbing the heavy metal ions as claimed in claim 1, wherein in the step (2), the polymer is one or more selected from the group consisting of carboxymethyl cellulose (CMC), chitosan, polyvinyl alcohol, and polyethylene glycol, and a weight ratio of the polymer to the GO is 0.125-2:1.

6. The preparation method of the graphene-based composite aerogel material for adsorbing the heavy metal ions as claimed in claim 1, wherein in the step (2), the ultrasonicating is under a power in a range of 100 watts (W) to 300 W for 0.5 hours (h) to 2 h, and the stirring specifically lasts for 0.5 h to 2 h.

7. The preparation method of the graphene-based composite aerogel material for adsorbing the heavy metal ions as claimed in claim 1, wherein in the step (3), a weight concentration of the diethylenetriamine is in a range of 3% to 10%, and time for the stirring is in a range of 4 h to 12 h.

8. The preparation method of the graphene-based composite aerogel material for adsorbing the heavy metal ions as claimed in claim 1, wherein in the step (3), a weight of the glucose is 2 to 6 times of a weight of the GO.

9. The preparation method of the graphene-based composite aerogel material for adsorbing the heavy metal ions as claimed in claim 1, wherein in the step (4), a temperature for the hydrothermal reaction is in a range of 60° C. to 100° C., and time for the hydrothermal reaction is in a range of 2 h to 8 h.

10. The preparation method of the graphene-based composite aerogel material for adsorbing the heavy metal ions as claimed in claim 1, wherein in the step (4), the rinsing operation comprises: rinsing by deionized water and dialyzing for 2 to 7 days until potential of hydrogen (pH) is in a range of 5 to 9, the freeze-drying operation comprises pre-freezing and then freeze-drying, a temperature for the pre-freezing is in a range of-5° C. to 196° C., time for the pre-freezing is in a range of 24 h to 72 h, a pressure for the freeze-drying is 2 pascals (Pa) to 50 Pa, a temperature for the freeze-drying is in a range of −5° C. to 196° C., and time for the freeze-drying is in a range of 24 h to 72 h.
